(19) United States
(12) Patent Application Publication
(10) Pub. No.: US 2026/0162975 A1
(43) Pub. Date: Jun. 11, 2026

(54) Silicon-graphene-graphite composite

(71) Applicant: ArcelorMittal, Luxembourg (LU)

(72) Inventors: Diego SAN MARTIN PINERA, Oviedo Asturias (ES); Marcos PEREZ RODRIGUEZ, Cangas Dei Narcea Asturias (ES); Cristina BOTAS VELASCO, Oviedo Asturias (ES); Roberto SUAREZ SANCHEZ, AVILES Asturias (ES); Gozde FIRTIN, Gijon Asturias (ES)

(21) Appl. No.: 19/123,189

(22) PCT Filed: Oct. 28, 2022
(86) PCT No.: PCT/IB2022/060376

§ 371 Date: Apr. 22, 2025

(51) Int. Cl. H01M 4/38; H01M 4/02; H01M 4/133; H01M 4/134; H01M 4/1393; H01M 4/1395; H01M 4/36; H01M 4/583; H01M 10/0525

(52) U.S. Cl. CPC H01M 4/386; H01M 4/133; H01M 4/134; H01M 4/1393; H01M 4/1395; H01M 4/364; H01M 4/583; H01M 10/0525; H01M 2004/021; H01M 2004/027

(57) ABSTRACT

A process of manufacturing a silicon-graphene-graphite composite for a Silicon-based anode of a lithium-ion battery, including bringing together silicon particles with a particle size distribution D₁₀ above 100 nm and an exfoliatable graphene-based material in a first organic solvent, the weight ratio of silicon to exfoliatable graphene-based material being between 1.5 and 9, mixing at at least 500 rpm for at least 20 min so as to mill the silicon particles into nanoparticles, exfoliate at least a part of the exfoliatable graphene-based material into graphene and form a silicon-graphene composite, bringing together the silicon-graphene composite and graphite, the weight ratio of carbon to silicon being between 1.5 and 19 and the viscosity being between 0.025 and 160 Pa·s at 1 s⁻¹ shear rate, and mixing for at least 2 min so as to form a silicon-graphene-graphite composite.

The present invention relates to a silicon-graphene-graphite composite for a silicon-based anode of a lithium-ion battery. The present invention also relates to the method for manufacturing silicon-graphene-graphite composite and the active material thereof.

### BACKGROUND

A typical lithium-ion cell comprises a carbon-based anode (e.g. graphite), a lithium metal oxide-based cathode (e.g. LiCoO₂), and a carbonate based organic electrolyte (e.g. ethylene carbonate (EC), dimethyl carbonate (DMC)) with a lithium salt (e.g. LiPF₆). Energy is stored in the electrodes as Li-intercalation compounds (LICs). Li⁺ ions intercalate and deintercalate between graphite (anode) and LiCoO₂ (cathode) through the electrolyte during discharge and charge, respectively.

### SUMMARY OF THE INVENTION

Carbon/graphite is the active material of choice for the anode. It has the ability to intercalate lithium into the structure with a small amount of expansion. Nevertheless, graphite-based anode offers a limited specific capacity (372 mA h g⁻¹) along with some critical issues including Li-plating, resulting in dendrite formation.

As promising anode materials for Lithium-ion Batteries, silicon has many advantages over graphite, such as very high capacity, wide availability, good stability, and environmental friendliness. In particular, it has the highest gravimetric capacity (4200 mA h g⁻¹, Li uptake to the Li₂₂Si₅ stoichiometry) and a volumetric capacity (9786 mA h cm⁻³, based on the initial volume of Si) superior to lithium metal.

However, certain obstacles prevent the use of silicon, namely huge volume expansions, low electrical conductivity, poor cycling performance and low faradaic efficiency in the first cycle. In particular, the volume expansion during Li-alloying (˜360% for Li₂₂Si₅) generates huge mechanical stress on repeated charging and discharging processes, resulting in a series of severely destructive consequences: gradually enhanced pulverization during repeated lithiation/delithiation cycles deteriorates the electrode structure; interfacial stress severs electrical connections between the active materials and current collector; and continuous formation-fracturing-reformation of solid electrolyte interface (SEI) film constantly consumes the electrolyte and lithium ions.

One strategy to overcome the above-mentioned limitations of Si anode materials involves building efficient conducting networks and external buffers for volume fluctuation of Si by combining it with a second phase, such as carbon, metal, ceramic and carbon-type compound like graphene and its derivatives.

It is known from H. Xiang, K. Zhang, G. Ji, J. Y. Lee, C. Zou, X. Chen, J. Wu, Graphene/nanosized silicon composites for lithium battery anodes with improved cycling stability, Carbon 49 (2011) 1787-1796, to blend nanosized Si particles with graphene sheets prepared by high temperature (1050° C.) thermal expansion of graphite.

Better than the simple fabrication of binary Si/graphene hybrids, the incorporation of another carbon phase, such as graphite or amorphous carbon, has been demonstrated to be another effective way for enhancing the cycle stability of Si-bases anodes.

It is known from C. C. Hsieh, W. R. Liu, Carbon-coated Si particles binding with few-layered graphene via a liquid exfoliation process as potential anode materials for lithium-ion batteries, Surf. Coating. Technol. 387 (2020) 125553, to fabricate a Si/few layer graphene/C composite (Si/FLG/C) by a) ultrasonicating a mixture of Si powder, few layer graphite and pitch (as carbon precursor) in acetone until the solvent is volatilized, b) drying in an oven for 1 h at 80° C. to remove the residual solvent, c) calcinating at 1000° C. for 2 h under argon flow at a rate of 5° C./min.

Nevertheless, the manufacturing of Si-based anodes with high mass loading and high areal capacity via a scalable, simple, and environment-friendly technique remains an unresolved concern.

It is an object of the present invention to remedy the drawbacks of the prior art by providing an efficient way of manufacturing a silicon-graphene composite.

The present invention provides a process of manufacturing a silicon-graphene-graphite composite for a Silicon-based anode of a lithium-ion battery, comprising:
(i) supplying silicon particles with a particle size distribution D₁₀ above 100 nm, an exfoliatable graphene-based material comprising at least 85 wt % of Carbon,
(ii) bringing together the silicon particles and the exfoliatable graphene-based material in a first organic solvent, the weight ratio of silicon to exfoliatable graphene-based material being comprised between 1.5 and 9,
(iii) mixing the composition of step (ii) at at least 500 rpm for at least 20 min so as to mill the silicon particles into nanoparticles, exfoliate at least a part of the exfoliatable graphene-based material into graphene and form a silicon-graphene composite,
(iv) bringing together the silicon-graphene composite and graphite, the weight ratio of carbon, from both graphene and graphite, to silicon being comprised between 1.5 and 19 and the viscosity being comprised between 0.025 and 160 Pa·s at 1 s⁻¹ shear rate, and
(v) mixing the composition of step (iv) for at least 2 min so as to form a silicon-graphene-graphite composite.

The process according to the present invention may also have the optional features listed below, considered individually or in combination:
the exfoliatable graphene-based material is selected among graphite, intercalated graphite, expanded graphite, graphite oxide, reduced graphite oxide, graphene oxide, reduced graphene oxide and mixture thereof,
the first organic solvent is selected among isopropanol, ethanol and their mixtures,
the weight ratio of silicon to the first organic solvent is below 0.66,
steps ii) and iii) are done concomitantly,
at the end of step iii), the Si particles have a particle size distribution D₅₀ of up to 70 nm,
the graphite of step iv) has a particle size distribution D₅₀ below 20 μm and a particle size distribution D₅₀ below 10 μm,
the graphite of step iv) is a battery-grade graphite,
a second solvent is added at step iv),
in steps iv) and v), the solid content is maintained above 11%,
in step v), the graphite is not exfoliated,
in step v), the mixing lasts less than 20 min,
the process further comprises a step (vi) of evaporating the solvent(s) from the silicon-graphene-graphite composite so as to dry the silicon-graphene-graphite composite,
the process further comprises a step vii) of thermally treating the silicon-graphene-graphite composite under inert atmosphere.

The present invention also provides a silicon-graphene-graphite composite for a Silicon-based anode of a lithium-ion battery comprising:
silicon particles with a particle size distribution D₅₀ of up to 70 nm wrapped in graphene layers,
graphite particles, the weight ratio of carbon to silicon being comprised between 1.5 and 19, and
a first organic solvent,
the viscosity of the silicon-graphene-graphite composite being comprised between 0.025 and 160 Pa·s at 1 s⁻¹ shear rate.

The present invention also provides an active material for a Silicon-based anode of a lithium-ion battery comprising a silicon-graphene-graphite composite comprising:
Silicon particles with a particle size distribution D₅₀ of up to 70 nm wrapped in graphene layers, and
graphite particles, the weight ratio of carbon to silicon being comprised between 1.5 and 19.

The present invention also provides a silicon-based anode of a lithium-ion battery comprising an active material according to the present invention.

The present invention also provides a lithium-ion battery comprising a silicon-based anode according to the present invention.

As it is apparent, the present invention is based, on one hand, on a first mixing step concomitantly milling Si particles into nanoparticles, exfoliating at least a part of an exfoliatable graphene-based material into graphene and wrapping the Si particles in the graphene layers to form a composite, and, on the other hand, on a careful control of the viscosity during a second mixing step wherein graphite is further introduced in the composite.

### BRIEF DESCRIPTION OF THE DRAWINGS

Other characteristics and advantages of the present invention will be described in greater detail in the following description.

The present invention will be better understood by reading the following description, which is provided purely for purposes of explanation and is in no way intended to be restrictive, with reference to:

FIG. 1, which is a SEM image of a biphasic mixture of silicon particles and exfoliatable graphene-based material mixed at 3350 rpm for 15 min,

FIG. 2, which is a SEM image of a silicon-graphene composite according to the invention,

FIG. 3, which is a SEM image of a silicon-graphene composite according to the invention,

FIG. 4, which is a EDX analysis of a biphasic mixture of silicon particles and exfoliatable graphene-based material mixed at less than 500 rpm for 30 min, and

FIG. 5, which is an EDX analysis of a silicon-graphene composite according to the invention.

### DETAILED DESCRIPTION

Nanoparticles are defined as particles having a particle size distribution D₅₀ below 100 nm.

In a first step (step i), silicon particles with a particle size distribution D₁₀ above 100 nm and an exfoliatable graphene-based material comprising at least 85 wt % of Carbon are supplied.

The Si particles have a particle size distribution D₁₀ above 100 nm, i.e. they are not nanoparticles. Avoiding nanoparticles as raw materials makes the handling of the raw materials safer. It is also more energy-efficient to mill the Si particles during the mixing with the exfoliatable graphene-based material than to mill them ahead of the mixing.

The Si particles have preferably a size within the submicron range. More preferably, the particle size distribution D₅₀ is below 1 μm. Even more preferably, D₅₀ is below 300 nm. This particle size distribution improves the yield of the mixing, i.e. the Si particles are efficiently milled while mixed with the exfoliatable graphene-based material, without requiring too much energy for the mixing.

The shape of the Si particles is not limited. It can be spherical or irregular.

The Si particles have preferably a purity of at least 98 wt %, preferably at least 99.9 wt %. The high purity of the Si particles improves the performances of the electrode and thus of the Lithium-Ion battery. Si can include impurities such Al, Ca, Fe, Ti, P, Cu, Cr, K, V, Ni, SiO₂ and Na.

The Si particles are preferably crystalline. It improves the performances of the electrode and thus of the Lithium-Ion battery.

The Si particles can be provided in an organic solvent. It prevents the silicon particles from oxidizing during transport and storage. Any organic solvent provides this advantage and can be used for that purpose. That said, alcohols are preferred as they have a low boiling point and further improve the dispersion of the Si particles. More preferably, the organic solvent is chosen among isopropanol, ethanol and their mixtures.

By exfoliatable graphene-based material it is meant that the material is based on graphene layers, i.e. on single layers of carbon atoms arranged in a two-dimensional honeycomb lattice nanostructure, that can be exfoliated or further exfoliated. There are no limitations on the way the graphene layers of the exfoliatable graphene-based material are stacked. It can be ABA stacking or ABC stacking. The graphene layers can notably be intercalated or expanded or partially exfoliated in monolayers, bilayers and/or few-layers.

Examples of possible exfoliatable graphene-based material are graphite, intercalated graphite, expanded graphite, graphite oxide, reduced graphite oxide, graphene oxide, reduced graphene oxide.

The exfoliatable graphene-based material is preferably a form of graphite. Graphite can be natural or synthetic. It can be Kish graphite.

The exfoliatable graphene-based material comprises at least 85 wt % of Carbon, preferably at least 97 wt %, more preferably at least 99 wt %. It improves the performances of the electrode and thus of the Lithium-Ion battery.

The particle size distribution of the exfoliatable graphene-based material is not limited. If the same material is to be used for steps iii) and iv), then it is preferred to use particles with a particle size distribution D₅₀ of maximum 20 μm. Otherwise, particles with size distributions D₅₀ as high as 250 μm or 500 μm can be used.

The exfoliatable graphene-based material is preferably in the form of nanoplatelets, i.e. nano-objects with one external dimension in the nanoscale and the other two external dimensions significantly larger, and not necessarily in the nanoscale. This favors the exfoliation of the exfoliatable graphene-based material and thus the wrapping of the Si particles.

The exfoliatable graphene-based material is preferably not partially exfoliated, more preferably not exfoliated. This makes the manufacturing more energy-efficient as the exfoliatable graphene-based material will only be exfoliated during the process according to the invention and it does not have to be exfoliated ahead of this process.

In a second step (step ii), the silicon particles and the exfoliatable graphene-based material are brought together in a first organic solvent.

The organic solvent prevents the silicon particle oxidation, prevents the silicon particle agglomeration and prevents the graphene layers from re-stacking once the exfoliatable graphene-based material has been exfoliated or further exfoliated. The organic solvent thus helps obtaining a homogeneous mixture.

Any organic solvent provides these advantages and can be used for that purpose. That said, alcohols are preferred as they have a low boiling point and further improve the dispersion of the Si particles. More preferably, the organic solvent is chosen among isopropanol, ethanol and their mixtures. For the sake of clarity, water is not considered as an organic solvent.

The first organic solvent can be the organic solvent in which the silicon particles can be dispersed when supplied at step (i).

The weight ratio of silicon to exfoliatable graphene-based material is comprised between 1.5 (which corresponds to 60 wt % of silicon and a ratio 60:40) and 9 (which corresponds to 90 wt % of silicon and a ratio 90:10). This range is important to achieve the right performances of the electrode and thus of the Lithium-Ion battery. Below 1.5, an excessive amount of exfoliatable graphene-based material is exfoliated during the process which impers the performances of the battery, in particular the coulombic efficiency. Above 9, there is not enough graphene to wrap the silicon particles. Consequently, the volume expansion of Silicon during Li-alloying is not properly buffered by graphene and the active material does not benefit from the high electrical conductivity of graphene.

The weight ratio of silicon to exfoliatable graphene-based material is preferably comprised between 3 and 6, which further improves the performances.

The weight ratio of silicon to organic solvent is preferably below 0.66 (which corresponds to 40 wt % of silicon and a ratio 40:60) to further prevent the oxidation of the Si particles and to ease the mixing. The weight ratio of silicon to organic solvent is preferably of at least 0.05 (which corresponds to 5 wt % of silicon and a ratio 5:95) to facilitate the wrapping of the Si particles in graphene and to accelerate the evaporation of the organic solvent at the end of the process. Limiting the quantity of organic solvent also prevents the Si particles and the exfoliatable graphene-based material (or the graphene obtained from this material) from settling in the solvent. More preferably, the weight ratio of silicon to organic solvent is comprised between 0.11 (which corresponds to 10 wt % of silicon and a ratio 10:90) and 0.43 (which corresponds to 30 wt % of silicon and a ratio 30:70) which further facilitates the process.

The solid content is preferably of at least 6%, more preferably of at least 20%, even more preferably between 20 and 30%. It prevents the Si particles and the exfoliatable graphene-based material (or the graphene obtained from this material) from settling in the solvent. Furthermore, it facilitates the next steps.

Preferably, in step (ii) no other elements than silicon particles, exfoliatable graphene-based material and organic solvent are brought together. Additional elements are not necessary to achieve the desired performances of the electrode and thus of the Lithium-Ion battery.

In a third step (iii), silicon particles, exfoliatable graphene-based material and the first organic solvent are mixed so as to form a silicon-graphene composite in the first organic solvent. This composite corresponds to Si nanoparticles wrapped in graphene layers.

The mixing is done at at least 500 rpm to create high shears that concomitantly:
Mill the Si particles into nanoparticles,
Exfoliate at least part of the exfoliatable graphene-based material into graphene, and
Wrap the Si particles in the graphene layers.

In particular, the Si particles are intercalated between the layers of graphene which favors the exfoliation of the exfoliatable graphene-based material. Furthermore, the wrapping of the Si particles in the graphene layers prevents the agglomeration of the Si particles or the re-stacking of graphene.

Below 500 rpm, the shear of the mixture is not enough to have the proper milling, exfoliation and wrapping. Consequently, the two phases remain and the mixture is not a composite. At 500 rpm, the silicon-graphene composite is formed. With higher mixing speeds, the exfoliatable graphene-based material can be further exfoliated. It further buffers the volume expansion of Silicon during Li-alloying and thus further improves the life span of the battery.

Preferably, the mixing speed is comprised between 1000 and 8000 rpm, more preferably between 2500 and 6000 rpm.

The mixing is done during at least 20 min. With shorter durations, there is not enough time for the Si particles to be milled and to get incorporated in the graphene obtained from the exfoliatable graphene-based material.

With longer mixing duration, the exfoliatable graphene-based material can be further exfoliated. It further buffers the volume expansion of Silicon during Li-alloying and thus further improves the life span of the battery.

Preferably, the mixing duration is comprised between 25 min and 1 h.

The mixing is preferably done in a high-shear mixer. The mixing is preferably done in a rotor-stator mixer, also known as impeller mixer. The mixer can notably be a blade mixer, a serrated blade mixer or a paddle mixer.

Steps ii) and iii) can be done concomitantly. In other words, the mixing can be started while all raw materials have not been added to the mixture yet. For example, it is possible to first bring the silicon particles and the organic solvent together and to start the mixing. The exfoliatable graphene-based material is then added step by step.

Step iii) can comprise one single mixing step or a plurality of successive mixing steps. In the latter case, the exfoliatable graphene-based material can be better exfoliated.

At the end of this step, the Si nanoparticles have preferably a size distribution D₅₀ of up to 70 nm. It further improves the buffering of the volume expansion of Silicon during Li-alloying and thus the performances of the battery.

The graphene obtained from the exfoliation of the exfoliatable graphene-based material is not limited to a single layer of carbon atoms. It comprises monolayer graphene, bilayer graphene and few-layered graphene. It can also be partially oxidized.

At the end of this step, a silicon-graphene composite is obtained. As a part of the exfoliatable graphene-based material may not have been exfoliated, or fully exfoliated, into graphene, the silicon-graphene composite can comprise a part of the exfoliatable graphene-based material. In this description, the term “silicon-graphene composite” refers to a composite comprising silicon, graphene as defined above and possibly an exfoliatable graphene-based material.

The silicon-graphene composite comprises silicon particles with a particle size distribution D₅₀ of up to 70 nm wrapped in graphene layers. In particular, the silicon-graphene composite comprises silicon particles with a particle size distribution D₅₀ of up to 70 nm wrapped in graphene layers from a graphene-based material. The weight ratio of silicon to the graphene-based material is comprised between 1.5 and 9. More particularly, the silicon-graphene composite comprises silicon particles with a particle size distribution D₅₀ of up to 70 nm wrapped in graphene layers exfoliated from an exfoliatable graphene-based material. The weight ratio of silicon to the exfoliatable graphene-based material is comprised between 1.5 and 9.

In a fourth step (step iv), the silicon-graphene composite in the first organic solvent previously obtained is brought together with graphite.

Addition of graphite to the silicon-graphene composite improves the electrical conductivity of the active material and thus the performances of the battery.

Graphite contains preferably more than 99% Cg to further improve the performances of the battery. Cg means carbon in graphitic form as opposed to carbon atoms which are tied up in the molecular structure of other minerals. Graphite is in the form of particles. It can be in the form of nanoplatelets or spheres. The graphite particles have preferably a particle size distribution D₅₀ below 20 μm and a particle size distribution D₅₀ below 10 μm.

Typical graphites for lithium-ion cells include (1) natural graphite, (2) graphitized mesocarbons or microbeads, formed by graphitization of mesophase pitch materials, (3) hard carbons formed by the pyrolysis of polymeric materials, and (4) natural or artificial graphite materials possibly coated with a hard or a soft carbon surface layer. It can also be Kish graphite.

Graphite is more preferably battery-grade graphite, also known as spherical graphite (SpG). It can be manufactured from flake graphite concentrates produced by graphite mines. In a first step, the process comprises micronizing, rounding and purifying flake graphite to produce uncoated SpG (uSpG). Micronizing involves reducing the flakes in size to approximately 10 to 15 microns. The rounding or spheronisation process decreases the surface area to allow more graphite into a smaller volume. This creates a smaller, denser, more efficient anode product for the battery. It also increases the rate at which the cell can be charged and discharged. Micronized and rounded material is then purified to approximately 99.95% Cg using hydrofluoric and sulphuric acid. In a second step, the spheres can be coated with a thin layer of pitch or asphalt and baked at over 1,200° C. This covers the uSpG with a hard carbon shell that protects the sphere from exfoliation and degradation during expansion and contraction with charging and discharging. It also inhibits the ongoing reaction of the electrolyte with the active graphite inside the sphere itself.

The weight ratio of graphite to silicon-graphene composite is adjusted so that the weight ratio of carbon to silicon is within the ranges detailed below.

The weight ratio of carbon to silicon is comprised between 1.5 (which corresponds to 40% of silicon and a ratio 60:40) and 19 (which corresponds to 5% of silicon and a ratio 95:5). The term “weight of carbon” refers to the weight of carbon from all sources of carbon, solvent(s) excluded. The sources of carbon are the graphene obtained in the third step, the graphite added in the present step and possibly a part of the exfoliatable graphene-based material which has not been exfoliated, or fully exfoliated, into graphene. Given the purity of the exfoliatable graphene-based material, it can be considered that the weight of carbon is the sum of the weight of exfoliatable graphene-based material added at the second step and of the weight of graphite added at the present step.

Below 1.5, there is not enough carbon to buffer the volume expansion of Silicon during Li-alloying. Above 19, the small addition of silicon does not provide enough capacity improvement to the battery. More preferably, the ratio of carbon to silicon is comprised between 1.86 (which corresponds to 35% of silicon and a ratio 65:35) and 9 (which corresponds to 10% of silicon and a ratio 90:10). It further improves the performance of the battery.

The viscosity of the silicon-graphene/graphite/solvent(s) mixture is comprised between 0.025 and 160 Pa·s at 1 s⁻¹ shear rate. This viscosity allows to obtain the silicon-graphene-graphite composite in one unique phase. It also prevents the Si particles from oxidizing. The viscosity of the mixture is preferably comprised between 0.4 and 50 Pa·s at 1 s⁻¹ shear rate, more preferably between 1 and 10 Pa·s at 1 s⁻¹ shear rate. It further favors the suspension of the graphite particles in the mixture and the homogeneity of the mixture.

The viscosity can be easily adjusted by the addition of a second solvent. Water or any organic solvent can be used for that purpose. That said, alcohols are preferred as they have a low boiling point and further improve the dispersion of the Si particles. More preferably, the second solvent is an organic solvent chosen among isopropanol, ethanol and their mixtures. The organic solvent can be the same as the first organic solvent of step (ii). It notably facilitates the waste management. Alternatively, the second solvent is a co-solvent of the first organic solvent that facilitates the evaporation of the solvents at a later stage. At that step, water is an option. The mixing is of limited duration and the silicon particles wrapped in graphene will not oxidize. Furthermore, as water is used for the manufacturing process of the electrode, it doesn't have to be evaporated from the silicon-graphene-graphite composite before starting the manufacturing process of the electrode.

Generally, the minimum viscosity corresponds more or less to a solid content of 11%. The solid content is thus preferably maintained above 11%. More preferably, the solid content is comprised between 11 and 40%.

In a fifth step (step v), silicon-graphene composite, graphite and the first organic solvent are mixed to form a silicon-graphene-graphite composite.

The type of mixing is not limited. It can notably be planetary mixing or mechanical mixing. Preferably, the mixing is done so that there is no chance graphite gets exfoliated, which would decrease the performance of the active material. Consequently, the mixer preferably does not have any impeller, such as blades or paddles.

The materials are mixed for at least 2 min to obtain a homogeneous mixture. The materials are preferably mixed for less than 20 min.

At the end of this step, a silicon-graphene-graphite composite is obtained. As explained in relation to the third step (step iii), a part of the exfoliatable graphene-based material may not have been exfoliated, or fully exfoliated, into graphene during the third step and the silicon-graphene composite can comprise a part of the exfoliatable graphene-based material. Consequently, the silicon-graphene-graphite composite can also comprise a part of the exfoliatable graphene-based material. In this description, the term “silicon-graphene-graphite composite” refers to a composite comprising silicon, graphene as defined above, graphite and possibly an exfoliatable graphene-based material other than graphite.

The silicon-graphene-graphite composite comprises the silicon-graphene composite as obtained at the end of the third step, graphite particles, the weight ratio of carbon to silicon being comprised between 1.5 and 19 and a first organic solvent, the viscosity of the silicon-graphene-graphite composite being comprised between 0.025 and 160 Pa·s at 1 s-1 shear rate.

According to one variant of the invention, in a sixth step (step vi), the solvent(s) are evaporated from the silicon-graphene-graphite composite so as to dry the composite and obtain the active material.

The evaporation of the solvent(s) is only optional as, in industrial processing, the active material may have to be dispersed in a solvent to do inks for electrode manufacturing.

Drying can notably be done by spray drying, freeze drying or by rotatory evaporation.

It can be assessed that the active material is dry notably by thermogravimetric analysis (TGA). In such case, no weight loss is observed at temperatures below 120° C.

In case the same organic solvent is used in steps (ii) and (iv), the organic solvent can be reused at the end of the evaporation step to manufacture more active material. It limits waste.

According to one variant of the invention, the active material is further thermally treated under inert atmosphere. It removes the possible slight oxidation of the Si particles, further increases the graphite quality and the graphene quality. Notably, in case the exfoliatable graphene-based material was in an oxidized form (notably graphene oxide or reduced graphene oxide), the thermal treatment under inert atmosphere reduces, or further reduces, the material. The inert gas is preferably chosen from hydrogen, argon, nitrogen and a mixture thereof. The temperature is preferably between 70° and 1500° C., more preferably between 90° and 1100° C. The minimum duration is preferably 30 min. The pressure can be atmospheric pressure or vacuum.

Once the silicon-graphene-graphite composite has been obtained, it can be used as active material for the manufacturing of silicon-based anodes Lithium-ion batteries. These anodes are composite electrodes. In addition to the active material, they comprise the following inactive materials: a binder to hold the electrode particles together, and an electron-conducting agent (i.e. carbon black) to increase the electronic conductivity. They are usually mixed all together to form inks or slurries in order to form relatively homogeneous and stable coatings on current collectors. The inactive materials are not directly involved in the electrochemical redox reactions, but they are nevertheless important for overall electrode functionality.

The binder is preferably a polymer binder. Commonly used polymer binders include polyvinylidene fluoride (PVDF), sodium carboxymethylcellulose/styrene-butadiene rubber (CMC/SBR), Polyacrylate (PAA), Lithium Polyacrylate (LiPAA), polyvinyl alcohol (PVA), sulfonated tetrafluoroethylene based fluoropolymer-copolymer (such as Nafion®), Sodium Alginate (SA), Chitosan (CS), guar gum (GG).

Once the silicon-based anode has been manufactured, it can be used for the manufacture of Lithium-ion batteries.

When the anode is first charged, it slowly approaches the lithium potential and begins to react with the electrolyte to form a film on the surface of the electrode. This film is composed of products resulting from the reduction reactions of the anode with the electrolyte. This film is called the solid electrolyte interphase (SEI) layer. Proper formation of the SEI layer is essential to good performance. Since the lithium in the cell comes from the lithium in the active cathode materials, any loss by formation of the SEI layer lowers the cell capacity. At the same time, the SEI layer protects the graphite surface from reaction with the electrolyte while providing a path for Li⁺ to enter and leave the anode structure.

It is considered that a Lithium-ion batteries based on an active material containing 16 wt % Silicone is efficient enough, if the First Coulombic Efficiency (FCE) is above 75%, the Electrode charge capacity (measured after 10 cycles) is above 700 mAh/g and the cyclability with the 80% of the initial capacity retention is above 500 cycles.

It is considered that a Lithium-ion batteries based on an active material containing 32 wt % Silicone is efficient enough, if the First Coulombic Efficiency (FCE) is above 65%, the Electrode charge capacity (measured after 10 cycles) is above 1200 mAh/g and the cyclability with the 80% of the initial capacity retention is above 250 cycles.

### EXAMPLES

### Example 1

The following raw materials were supplied:
12 g of silicon particles with a purity above 99% and a particle size distribution D₅₀ below 291 nm dispersed in isopropanol at 0.21 g/mL, which corresponds to a weight ratio of silicon to organic solvent of 21:79, and
3 g of Kish graphite cleaned in a previous step to reach a purity of 99.9 wt % C. The Kish graphite had a particle size distribution D₅₀ of 20 μm.

Silicon particles in isopropanol and Kish graphite were brought together at a weight ratio silicon/graphite of 4 (80:20). This was done without further addition of isopropanol. Consequently, the weight ratio of exfoliatable graphene-based material to solvent was of 5:95 and the solid content was of 26%.

The composition was high shear mixed in disperser Dispermat LC-30 at 3350 rpm for 30 minutes. 15 g of silicon-graphene composite in 44.24 g of isopropanol were obtained. The Si nanoparticles of the composite had a size distribution D₅₀ of 70 nm.

The 15 g of silicon-graphene composite dispersed in 44.24 g of isopropanol was then brought with 60 g of Kish graphite, at a weight ratio graphite/composite of 4 (80:20), which corresponds to a ratio carbon/silicon of 5.25 (84:16). 120 mL of isopropanol were added to reach a viscosity of 152.16 Pa·s at 1 s⁻¹ shear rate. Consequently, the solid content was of 37%. The Kish graphite had been cleaned in a previous step to reach a purity of 99.9 wt % C, it had a particle size distribution D₅₀ of 20 μm, a particle size distribution D₅₀ of 10 μm and a nanoplatelet shape.

The mixture was mixed in a Kakuhunter SK-350TII mixer for 5 minutes and then dried in a rotatory evaporator at 60° C., under vacuum for 1 h to obtain a 16 wt % Silicone-4 wt % graphene-80 wt % graphite composite.

To test the performances of this active material, it was mixed with Lithium Polyacrylate (LiPAA) and Carbon black C45 in a ratio 80:10:10 in water in disperser Dispermat LC-30 at 5000 rpm for 1 h. The obtained ink was then applied on a copper foil using a doctor blade to form a 100p thick wet coating. It was dried in a vacuum oven at 80° C. for 12 h. The dry coating was 70p thick.

The electrode made of the coated copper foil was tested in a coin cell as half-cell versus lithium in the following conditions:
Electrolyte: 1 mol/L of Lithium hexafluorophosphate (LiPF₆) in a solvent comprising a 3:7 volume ratio of Fluoroethylene carbonate (FEC) to Ethyl methyl carbonate (EMC), with 2 wt. % Vinylene carbonate (VC),
Cycling protocol:
   1 cycle at Constant Current at rate C/20 followed by 5 cycles at Constant Current at rate C/10, in a voltage window of 0.01-1.0 V vs Li/Li⁺, to form the SEI layer,
   1 cycle at Constant Voltage at a maximum current rate C/40 followed by 1 cycle at Constant Voltage at a maximum current rate C/20,
   The repetition of 24 cycles at Constant Current at rate C/2 in a voltage window of 0.01-1.0 V vs Li/Li⁺, followed by 1 cycle at Constant Current at rate C/10 in a voltage window of 0.01-1.0 V vs Li/Li⁺, and 1 cycle at Constant Voltage at a maximum current rate C/10.

Where C is the battery capacity, i.e. the maximum amount of energy that can be extracted from the battery, expressed in ampere-hours (Ah).

Table 1 summarizes the results obtained:

TABLE 1

| FCE | CEₙ₁₀ | Charge capacity (mAh/g active material) | | | | | | | | | |
|---|---|---|---|---|---|---|---|---|---|---|---|
| (%) | (%) | n1 | n10 | n50 | n100 | n200 | n300 | n400 | n500 | n600 | n700 |
| 84 | 99.2 | 904 | 824 | 774 | 744 | 676 | 704 | 715 | 668 | 654 | 639 |

n: cycle number. FCE: First Coulombic efficiency. CEₙ₁₀: Coulombic efficiency of cycle number 10

As it is visible, thanks to the composite prepared with the process according to the invention, the electrode displays very good performances, such as a FCE of 84%, a capacity of 824 mAh/g of active material and a cyclability of 600 cycles.

### Example 2

Example 2 differs from Example 1 in that reduced graphene oxide (rGO) with a purity above 97 wt % C, a particle size distribution D₅₀ of 10 μm and a platelet shape were used instead of Kish graphite as the exfoliatable graphene-based material. Also, graphite was mixed with the silicon-graphene composite instead of Kish graphite.

Silicon particles in isopropanol and rGO were brought together at a weight ratio silicon/rGO of 4 (80:20). This was done without further addition of isopropanol. Consequently, the weight ratio of exfoliatable graphene-based material to solvent was of 5:95 and the solid content was of 26%.

The composition was high shear mixed in disperser Dispermat LC-30 at 3350 rpm for 30 minutes. 4 g of silicon-graphene composite in 20 g of isopropanol were obtained. The Si nanoparticles of the composite had a size distribution D₅₀ of 70 nm.

The 4 g of silicon-graphene composite dispersed in 20 g of isopropanol was then brought with 16.3 g of graphite (purity of 99.9 wt % C, D₅₀ of 20 μm, D₅₀ of 10 μm, nanoplatelet shape, supplied by Imerys) at a weight ratio graphite/composite of 4 (80:20), which corresponds to a ratio carbon/silicon of 5.25 (84:16). 40 mL of isopropanol were added. Consequently, the solid content was of 28%.

The mixture was mixed in a Kakuhunter SK-350TII mixer for 5 minutes and then dried in a rotatory evaporator at 60° C., under vacuum for 1 h to obtain a 16 wt % Silicone-4 wt % graphene-80 wt % graphite composite.

The obtained 16 wt % Silicone-4 wt % graphene-80 wt % graphite composite was tested in the same conditions as in Example 1.

Table 2 summarizes the results obtained:

TABLE 2

| FCE | CEₙ₁₀ | Charge capacity (mAh/g active material) | | | | | | | | | |
|---|---|---|---|---|---|---|---|---|---|---|---|
| (%) | (%) | n1 | n10 | n50 | n100 | n200 | n300 | n400 | n500 | n600 | n700 |
| 80.21 | 99.91 | 768 | 723 | 683 | 647 | 614 | 604 | N/A | N/A | N/A | N/A |

n: cycle number. FCE: First Coulombic efficiency. CEₙ₁₀: Coulombic efficiency of cycle number 10

As it is visible, thanks to the composite prepared with the process according to the invention, the electrode displays very good performances, such as a FCE of 80% and a capacity of 723 mAh/g of active material.

### Example 3

Example 3 differs from Example 1 in that 3 g of expanded graphite (EG) with a purity of 99 wt % C and a particle size distribution D₅₀ of 20 μm were used instead of Kish graphite. Also, the mixing conditions were different.

Silicon particles in isopropanol and expanded graphite were brought together at a weight ratio silicon/graphite of 4 (80:20). This was done by adding 77 g of isopropanol. Consequently, the weight ratio of silicon to organic solvent was of 7:93, the weight ratio of exfoliatable graphene-based material to solvent was of 2:98 and the solid content was of 8%.

The composition was high shear mixed in a Silverson L5 mixer at 3000 rpm for 30 minutes. 15 g of silicon-graphene composite in 132.43 g of isopropanol were obtained. The Si nanoparticles of the composite had a size distribution D₅₀ of 70 nm.

The 15 g of silicon-graphene composite dispersed in 132.43 g of isopropanol was then brought with 60 g of Kish graphite at a weight ratio graphite/composite of 4 (80:20), which corresponds to a ratio carbon/silicon of 5.25 (84:16). No isopropanol was added. Consequently, the solid content was of 36%. The Kish graphite had been cleaned in a previous step to reach a purity of 99.9 wt % C, it had a particle size distribution D₅₀ of 20 μm, a particle size distribution D₅₀ of 10 μm and a nanoplatelet shape.

The mixture was mixed in a Kakuhunter SK-350TII mixer for 5 minutes and then dried in a rotatory evaporator at 60° C., under vacuum for 1 h to obtain a 16 wt % Silicone-4 wt % graphene-80 wt % graphite composite.

The obtained 16 wt % Silicone-4 wt % graphene-80 wt % graphite composite was tested in the same conditions as in Example 1.

Table 3 summarizes the results obtained:

TABLE 3

| FCE | CEₙ₁₀ | Charge capacity (mAh/g active material) | | | | | | | | | |
|---|---|---|---|---|---|---|---|---|---|---|---|
| (%) | (%) | n1 | n10 | n50 | n100 | n200 | n300 | n400 | n500 | n600 | n700 |
| 83.69 | 99.35 | 862 | 714 | 747 | 683 | 642 | 627 | N/A | N/A | N/A | N/A |

n: cycle number. FCE: First Coulombic efficiency. CEₙ₁₀: Coulombic efficiency of cycle number 10

As it is visible, thanks to the composite prepared with the process according to the invention, the electrode displays very good performances, such as a FCE of 84% and a capacity of 714 mAh/g of active material.

### Example 4

Example 4 differs from Example 1 in that 3 g of graphite with a purity of 99.9 wt % C and a particle size distribution D₅₀ of 20 μm (supplied by Imerys) were used instead of Kish graphite as the exfoliatable graphene-based material. Also, graphite was mixed with the silicon-graphene composite instead of Kish graphite.

Silicon particles in isopropanol and graphite were brought together at a weight ratio silicon/graphite of 4 (80:20). This was done without further addition of isopropanol. Consequently, the weight ratio of exfoliatable graphene-based material to solvent was of 5:95 and the solid content was of 26%.

The composition was high shear mixed in disperser Dispermat LC-30 at 3350 rpm for 30 minutes. 15 g of silicon-graphene composite in 44.24 g of isopropanol were obtained. The Si nanoparticles of the composite had a size distribution D₅₀ of 70 nm.

The 15 g of silicon-graphene composite dispersed in 44.24 g of isopropanol was then brought with 60 g of graphite (purity of 99.9 wt % C, D₅₀ of 20 μm, D₅₀ of 10 μm, nanoplatelet shape, supplied by Imerys) at a weight ratio graphite/composite of 4 (80:20), which corresponds to a ratio carbon/silicon of 5.25 (84:16). 120 mL of isopropanol were added to reach a viscosity of 152.16 Pa·s at 1 s⁻¹ shear rate. Consequently, the solid content was of 29.4%.

The mixture was mixed in a Kakuhunter SK-350TII mixer for 5 minutes and then dried in a rotatory evaporator at 60° C., under vacuum for 1 h to obtain a 16 wt % Silicone-4 wt % graphene-80 wt % graphite composite.

The obtained 16 wt % Silicone-4 wt % graphene-80 wt % graphite composite was tested in the same conditions as in Example 1.

Table 4 summarizes the results obtained:

TABLE 4

| FCE | CEₙ₁₀ | Charge capacity (mAh/g active material) | | | | | | | | | |
|---|---|---|---|---|---|---|---|---|---|---|---|
| (%) | (%) | n1 | n10 | n50 | n100 | n200 | n300 | n400 | n500 | n600 | n700 |
| 83.30 | 99.36 | 824 | 790 | 724 | 680 | 657 | 619 | N/A | N/A | N/A | N/A |

n: cycle number. FCE: First Coulombic efficiency. CEₙ₁₀: Coulombic efficiency of cycle number 10

As it is visible, thanks to the composite prepared with the process according to the invention, the electrode displays very good performances, such as a FCE of 83% and a capacity of 790 mAh/g of active material.

### Example 5

Example 5 differs from Example 1 by a different weight ratio of silicon to organic solvent in the second step. Also, the mixing conditions were different.

12 g of silicon particles in isopropanol and 3 g of Kish graphite were brought together at a weight ratio silicon/graphite of 4 (80:20). 172 g of isopropanol were added. Consequently, the weight ratio of silicon to organic solvent was of 5:95, the weight ratio of exfoliatable graphene-based material to solvent was of 1:99 and the solid content was of 6.9%.

The composition was high shear mixed in a Silverson L5 mixer at 3000 rpm for 30 minutes. 15 g of silicon-graphene composite in 217.4 g of isopropanol were obtained. The Si nanoparticles of the composite had a size distribution D₅₀ of 70 nm.

The 15 g of silicon-graphene composite dispersed in isopropanol was then brought with 60 g of Kish graphite, at a weight ratio graphite/composite of 4 (80:20), which corresponds to a ratio carbon/silicon of 5.25 (84:16). No isopropanol was added. Consequently, the solid content was of 25.8%. The Kish graphite had been cleaned in a previous step to reach a purity of 99.9 wt % C, it had a particle size distribution D₅₀ of 20 μm, a particle size distribution D₅₀ of 10 μm and a nanoplatelet shape.

The mixture was mixed in a Kakuhunter SK-350TII mixer for 5 minutes and then dried in a rotatory evaporator at 60° C., under vacuum for 1 h to obtain a 16 wt % Silicone-4 wt % graphene-80 wt % graphite composite.

The obtained 16 wt % Silicone-4 wt % graphene-80 wt % graphite composite was tested in the same conditions as in Example 1.

Table 5 summarizes the results obtained:

TABLE 5

| FCE | CEₙ₁₀ | Charge capacity (mAh/g active material) | | | | | | | | | |
|---|---|---|---|---|---|---|---|---|---|---|---|
| (%) | (%) | n1 | n10 | n50 | n100 | n200 | n300 | n400 | n500 | n600 | n700 |
| 83.18 | 99.37 | 857 | 803 | 719 | 609 | 654 | 667 | N/A | N/A | N/A | N/A |

n: cycle number. FCE: First Coulombic efficiency. CEₙ₁₀: Coulombic efficiency of cycle number 10

As it is visible, thanks to the composite prepared with the process according to the invention, the electrode displays very good performances, such as a FCE of 83% and a capacity of 803 mAh/g of active material.

### Example 6

Example 6 differs from Example 4 in that the obtained 16 wt % Silicone-4 wt % graphene-80 wt % graphite composite was further heat treated at 850° C., for 3 h under Argon.

The heat-treated composite was tested in the same conditions as in Example 1.

Table 6 summarizes the results obtained:

TABLE 6

| FCE | CEₙ₁₀ | Charge capacity (mAh/g active material) | | | | | | | | | |
|---|---|---|---|---|---|---|---|---|---|---|---|
| (%) | (%) | n1 | n10 | n50 | n100 | n200 | n300 | n400 | n500 | n600 | n700 |
| 80.0 | 99.11 | 877 | 828 | 759 | 728 | N/A | N/A | N/A | N/A | N/A | N/A |

n: cycle number. FCE: First Coulombic efficiency. CEₙ₁₀: Coulombic efficiency of cycle number 10

The additional heat treatment reduces the silicon oxidation and homogenizes the composite distribution. It improves the conductivity and stability of the anode.

### Counterexample 1

The following raw materials were supplied:
810 g of silicon particles with a purity of 99% and a particle size distribution D₅₀ of 200 μm, and
270 g of expanded graphite (EG) with a purity of 99 wt % C and a particle size distribution D₅₀ of 20 μm.

The expanded graphite was first exfoliated in a three-roll mill (Buhler Trias-300) for seven passes in gap mode, with isopropanol to reach an initial solid content of 17%. The silicon particles were pre-milled in a bead mill (Buhler PML2 Centex S2 SiC) at 1,450 kWh/t and then fine milled in a bead mill (Buhler MicroMedia MMX1) at 30,000 kWh/t to obtain a particle size distribution D₅₀ of 150 nm and D₅₀ of 85 nm. The exfoliated expanded graphite was then added to the silicon particles in the Buhler PML2 Centex S2 SiC mill with 4.66 Kg of isopropanol, which corresponds to a solid content of 20.7%, a weight ratio of Si to exfoliatable graphene-based material of 75:25, a weight ratio of silicon to organic solvent of 16:84 and a weight ratio exfoliatable graphene-based material to solvent of 5:95. Exfoliated expanded graphite and silicon particles in isopropanol were mixed in a bead mill at a tip speed of 11.1 m/s for 1.25 hours and then dried in a rotatory evaporator at 60° C., under vacuum for 1 h to obtain a 75 wt % silicon-25 wt % graphene composite.

To test the performances of this active material, it was mixed with Lithium Polyacrylate (LiPAA) and Carbon black C45 in a ratio 80:10:10 in water in disperser Dispermat LC-30 at 5000 rpm for 1 h. The obtained ink was then applied on a copper foil using a doctor blade to form a 100p thick wet coating. It was dried in a vacuum oven at 80° C. for 12 h. The dry coating was 70p thick.

The electrode made of the coated copper foil was tested in a coin cell as half-cell versus lithium in the following conditions:
Electrolyte: 1 mol/L of Lithium hexafluorophosphate (LiPF₆) in a solvent comprising a 3:7 volume ratio of Fluoroethylene carbonate (FEC) to Ethyl methyl carbonate (EMC), with 2 wt. % Vinylene carbonate (VC),
Cycling protocol:
   The repetition of 1 cycle at Constant Current at a rate C/5 in a voltage window of 0.05-0.9 V vs Li/Li⁺, and 1 cycle at Constant voltage at a maximum current rate C/10.

Table 7 summarizes the results obtained:

TABLE 7

| FCE | CEₙ₁₀ | Charge capacity (mAh/g active material) | | | | | | | | | |
|---|---|---|---|---|---|---|---|---|---|---|---|
| (%) | (%) | n1 | n10 | n50 | n100 | n200 | n300 | n400 | n500 | n600 | n700 |
| 58.30 | 99.55 | 744 | 487 | 373 | N/A | N/A | N/A | N/A | N/A | N/A | N/A |

n: cycle number. FCE: First Coulombic efficiency. CEₙ₁₀: Coulombic efficiency of cycle number 10

As it is visible, when silicon particles and graphene are prepared separately and not mixed with graphite, good performances are not reached. In addition, the methodology is expensive, energetically inefficient, time consuming and the silicon particles are not well included in the carbon matrix.

### Counterexample 2

The following raw materials were supplied:
4 g of silicon particles with a purity above 99% and a particle size distribution D₅₀ below 291 nm dispersed in isopropanol at 0.21 g/mL, which corresponds to a weight ratio of silicon to organic solvent of 21:79, and
4 g of graphite with a purity of 99.9 wt % C and a particle size distribution D₅₀ of 20 μm (supplied by Imerys).

Silicon particles in isopropanol and graphite were brought together at a weight ratio silicon/graphite of 1 (50:50). This was done without further addition of isopropanol. Consequently, the weight ratio of exfoliatable graphene-based material to solvent was of 21:79 and the solid content was of 37%.

The composition was high shear mixed in disperser Dispermat LC-30 at 3350 rpm for 30 minutes. 8 g of silicon-graphene composite in 13.5 g of isopropanol were obtained. The Si nanoparticles of the composite had a size distribution D₅₀ of 70 nm.

The 8 g of silicon-graphene composite dispersed in 13.5 g of isopropanol was then brought with 17 g of graphite (purity of 99.9 wt % C, D₅₀ of 20 μm, D₅₀ of 10 μm, nanoplatelet shape, supplied by Imerys), at a weight ratio graphite/composite of 2.12 (68:32), which corresponds to a ratio carbon/silicon of 5.25 (84:16). 57 mL of isopropanol were added.

The mixture was mixed in a Kakuhunter SK-350TII mixer for 5 minutes and then dried in a rotatory evaporator at 60° C., under vacuum for 1 h to obtain a 16 wt % Silicone-16 wt % graphene-68 wt % graphite composite.

The obtained 16 wt % Silicone-16 wt % graphene-68 wt % graphite composite was tested in the same conditions as in Example 1.

Table 8 summarizes the results obtained:

TABLE 8

| | | Charge capacity (mAh/g active material) | | | |
|---|---|---|---|---|---|
| FCE (%) | CEₙ₁₀ (%) | n1 | n10 | n30 | n50 |
| 85.25 | 99 | 791.6 | 704.6 | 567.0 | 532.48 |

n: cycle number.
FCE: First Coulombic efficiency.
CEₙ₁₀: Coulombic efficiency of cycle number 10

As it is visible, when the weight ratio silicon/exfoliated graphene-based material is below 1.5 (60:40), the performances of the electrode are not satisfactory. In particular, the cyclability with the 80% of the initial capacity retention is limited to 30 cycles.

### Counterexample 3

The following raw materials were supplied:
4 g of silicon particles with a purity above 99% and a particle size distribution D₅₀ below 291 nm dispersed in isopropanol at 0.21 g/mL, which corresponds to a weight ratio of silicon to organic solvent of 21:79, and
0.21 g of graphite with a purity of 99.9 wt % C and a particle size distribution D₅₀ of 20 μm (supplied by Imerys).

Silicon particles in isopropanol and graphite were brought together at a weight ratio silicon/graphite of 19 (95:5). This was done without further addition of isopropanol. Consequently, the weight ratio of exfoliatable graphene-based material to solvent was of 2:98 and the solid content was of 24%.

The composition was high shear mixed in disperser Dispermat LC-30 at 3350 rpm for 30 minutes. 4.21 g of silicon-graphene composite in 13.5 g of isopropanol were obtained. The Si nanoparticles of the composite had a size distribution D₅₀ of 70 nm.

The 4.21 g of silicon-graphene composite dispersed in 13.5 g of isopropanol was then brought with 20.79 g of graphite (purity of 99.9 wt % C, D₅₀ of 20 μm, D₅₀ of 10 μm, nanoplatelet shape, supplied by Imerys), at a weight ratio graphite/composite of 2.12 (68:32), which corresponds to a ratio carbon/silicon of 5.25 (84:16). 62 mL of isopropanol were added.

The mixture was mixed in a Kakuhunter SK-350TII mixer for 5 minutes and then dried in a rotatory evaporator at 60° C., under vacuum for 1 h to obtain a 16 wt % Silicone-0.842 wt % graphene-83.158 wt % graphite composite.

The obtained 16 wt % Silicone-0.842 wt % graphene-83.158 wt % graphite composite was tested in the same conditions as in Example 1.

Table 9 summarizes the results obtained:

TABLE 9

| FCE | CEₙ₁₀ | Charge capacity (mAh/g active material) | | | | | | | | | |
|---|---|---|---|---|---|---|---|---|---|---|---|
| (%) | (%) | n1 | n10 | n20 | n40 | n60 | n80 | n100 | n120 | n140 | n160 |
| 81.59 | 99.32 | 902 | 803 | 751 | 677 | 650 | 630 | 605 | 608 | N/A | N/A |

n: cycle number. FCE: First Coulombic efficiency. CEₙ₁₀: Coulombic efficiency of cycle number 10

As it is visible, when the weight ratio silicon/exfoliated graphene-based material is above 9 (90:10), the performances of the electrode are not satisfactory. In particular, the cyclability with the 80% of the initial capacity retention is limited to less than 80 cycles.

### Effect of the Mixing Duration on the Obtaining of the Silicon-Graphene Composite

The following raw materials were supplied:
4 g of silicon particles with purity above 99% and a particle size distribution D₉₀ below 291 nm dispersed in isopropanol at 0.21 g/mL, which corresponds to a weight ratio of silicon to organic solvent of 21:79, and
1 g of Kish graphite cleaned in a previous step to reach a purity of 99.9 wt % C. The Kish graphite had a particle size distribution D₉₀ of 20 μm.

Silicon particles in isopropanol and Kish graphite were brought together at a weight ratio silicon/graphite of 4 (80:20). This was done without further addition of isopropanol. Consequently, the weight ratio of exfoliatable graphene-based material to solvent was of 5:95 and the solid content was of 26%.

The composition was high shear mixed in disperser Dispermat LC-30 at 3350 rpm for different durations. The homogeneity of the mixture was then observed by SEM.

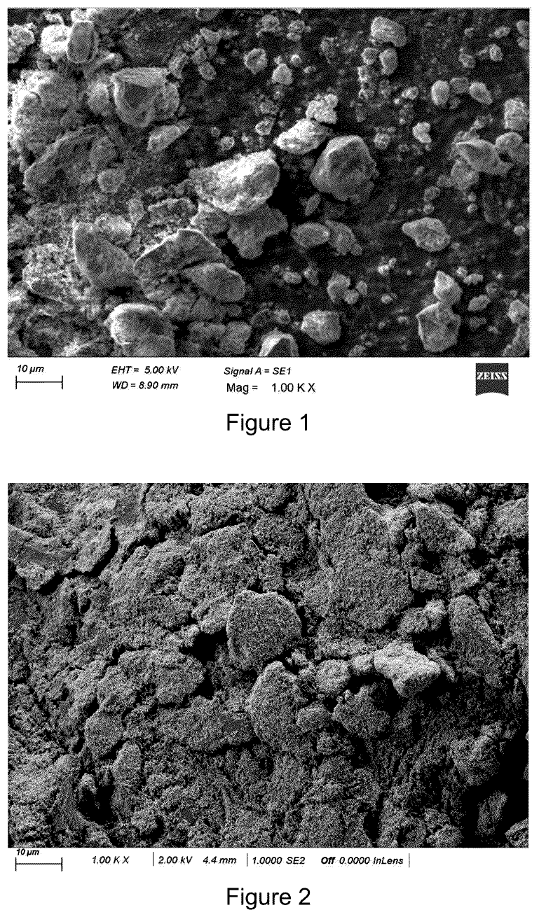

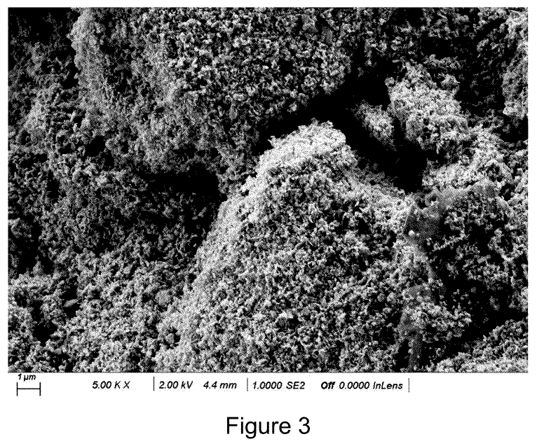

Table 10 summarizes the results obtained:

| | Duration | Homogeneity of the | Representative |
|---|---|---|---|
| Duration ref | (min) | mixture | figure |
| 1 | 1 | Heterogeneous | FIG. 1 |
| 2 | 5 | Heterogeneous | |
| 3 | 10 | Heterogeneous | |
| 4 | 15 | Heterogeneous | |
| 5 | 20 | Homogeneous | FIGS. 2 and 3 |
| 6 | 25 | Homogeneous | |
| 7 | 30 | Homogeneous | |
| 8 | 60 | Homogeneous | |

### Effect of the Mixing Speed on the Obtaining of the Silicon-Graphene Composite

The following raw materials were supplied:
4 g of silicon particles with purity above 99% and a particle size distribution D₉₀ below 291 nm dispersed in isopropanol at 0.21 g/mL, which corresponds to a weight ratio of silicon to organic solvent of 21:79, and
1 g of Kish graphite cleaned in a previous step to reach a purity of 99.9 wt % C. The Kish graphite had a particle size distribution D₉₀ of 20 μm.

Silicon particles in isopropanol and Kish graphite were brought together at a weight ratio silicon/graphite of 4 (80:20). This was done without further addition of isopropanol. Consequently, the weight ratio of exfoliatable graphene-based material to solvent was of 5:95 and the solid content was of 26%.

The composition was high shear mixed in disperser Dispermat LC-30 for 30 min at different speeds. The homogeneity of the mixture was then observed by SEM and EDX.

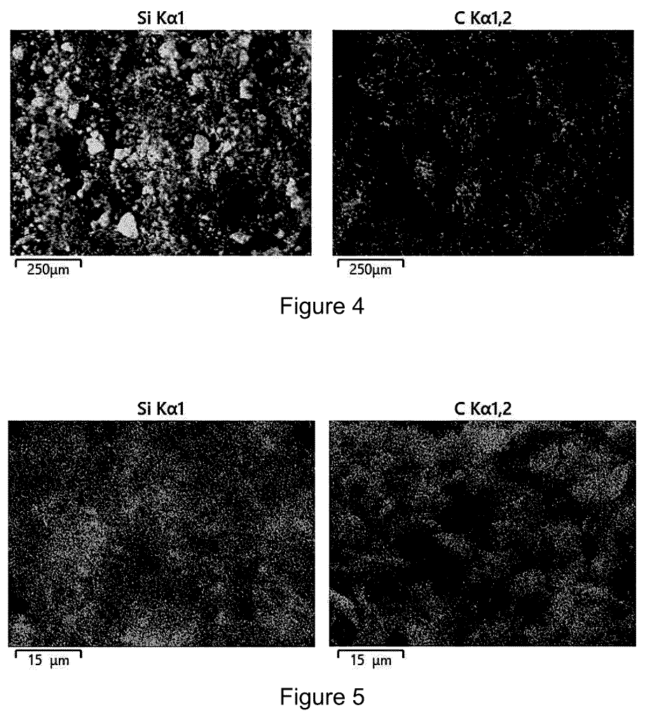

Table 11 summarizes the results obtained:

| Speed | Speed | Homogeneity of | Representative |
|---|---|---|---|
| ref | (rpm) | the mixture | figure |
| 1 | 490 | Heterogeneous | FIG. 4 |
| 2 | 500 | Homogeneous | FIG. 5 |
| 3 | 3350 | Homogeneous | |
| 4 | 6000 | Homogeneous | |

Effect of the Viscosity on the Mixing of Graphite with the Silicon-Graphene Composite

The following raw materials were supplied:
4 g of silicon particles with purity above 99% and a particle size distribution D₉₀ below 291 nm dispersed in isopropanol at 0.21 g/mL, which corresponds to a weight ratio of silicon to organic solvent of 21:79, and
1 g of Kish graphite cleaned in a previous step to reach a purity of 99.9 wt % C. The Kish graphite had a particle size distribution D₉₀ of 20 μm.

Silicon particles in isopropanol and Kish graphite were brought together at a weight ratio silicon/graphite of 4 (80:20). This was done without further addition of isopropanol. Consequently, the weight ratio of exfoliatable graphene-based material to solvent was of 5:95 and the solid content was of 26%.

The composition was high shear mixed in disperser Dispermat LC-30 at 3350 rpm for 30 minutes. 5 g of silicon-graphene composite in 14.7 g of isopropanol were obtained. The Si nanoparticles of the composite had a size distribution D₅₀ of 70 nm.

The 5 g of silicon-graphene composite dispersed in 20.2 g of isopropanol was then brought with 20 g of Kish graphite, at a weight ratio graphite/composite of 4 (80:20), which corresponds to a ratio carbon/silicon of 5.25 (84:16). The Kish graphite had been cleaned in a previous step to reach a purity of 99.9 wt % C, it had a particle size distribution D₉₀ of 20 μm, a particle size distribution D₅₀ of 10 μm and a nanoplatelet shape. Various quantities of isopropanol were added to reach a variety of viscosities.

The mixture was mixed in a Kakuhunter SK-350TII mixer for 5 minutes. When a unique phase was obtained, the viscosity was measured with a viscometer IKA Rotavisc hi-vi I at room conditions. The homogeneity of the mixture was observed with naked eyes and/or by SEM.

Table 12 summarizes the results obtained:

| | | Viscosity | Solid | |
|---|---|---|---|---|
| | Isopropanol | (Pa · s at 1 s⁻¹ | content | Homogeneity of |
| Dilution ref | (mL) | shear rate) | (%) | the mixture |
| 1 | 30 | Not measured | 36.4 | Heterogeneous |
| 2 | 60 | 152.16 | 31.2 | homogeneous |
| 3 | 90 | 7.49 | 22.7 | homogeneous |
| 4 | 120 | 1.37 | 17.8 | homogeneous |
| 5 | 150 | 0.49 | 14.7 | homogeneous |
| 6 | 200 | 0.025 | 11.4 | homogeneous |
| 7 | 230 | Not measured | 10.2 | Heterogeneous |

As visible from the results, controlling the viscosity of the mixture of silicon-graphene composite and graphite is key to obtain a homogeneous mixture. Not enough dilution and too much dilution prevent the mixture from becoming homogeneous.

What is claimed is:

1-15. (canceled)

16: A process for manufacturing a silicon-graphene-graphite composite for a Silicon-based anode of a lithium-ion battery, the process comprising:
(i) supplying silicon particles with a particle size distribution D₁₀ above 100 nm, and an exfoliatable graphene-based material including at least 85 wt % of Carbon;
(ii) bringing together the silicon particles and the exfoliatable graphene-based material in a first organic solvent, a weight ratio of silicon to the exfoliatable graphene-based material being between 1.5 and 9;
(iii) mixing the composition of step (ii) at at least 500 rpm for at least 20 min to mill the silicon particles into nanoparticles, exfoliate at least a part of the exfoliatable graphene-based material into graphene and form a silicon-graphene composite;
(iv) bringing together the silicon-graphene composite and graphite, a weight ratio of carbon to silicon being between 1.5 and 19 and the viscosity being between 0.025 and 160 Pa·s at 1 s⁻¹ shear rate; and
(v) mixing the composition of step (iv) for at least 2 min to form a silicon-graphene-graphite composite.

17: The process according to claim 16 wherein the exfoliatable graphene-based material is chosen from at least one of the group consisting of: graphite, intercalated graphite, expanded graphite, graphite oxide, reduced graphite oxide, graphene oxide, reduced graphene oxide and a mixture thereof.

18: The process according to claim 16 wherein the first organic solvent is chosen from at least one of the group consisting of: isopropanol, ethanol and a mixture thereof.

19: The process according to claim 16 wherein a weight ratio of silicon to the first organic solvent is below 0.66.

20: The process according to claim 16 wherein steps ii) and iii) are performed concomitantly.

21: The process according to claim 16 wherein at the end of step iii), the silicon particles have a particle size distribution D₅₀ of up to 70 nm.

22: The process according to claim 16 wherein graphite of step iv) has a particle size distribution D₉₀ below 20 μm and a particle size distribution D₅₀ below 10 μm.

23: The process according to claim 16 wherein graphite of step iv) is a battery-grade graphite.

24: The process according to claim 16 wherein a second solvent is added at step iv).

25: The process according to claim 16 wherein, in steps iv) and v), a solid content is maintained above 11%.

26: The process according to claim 16 wherein, in step v), the mixing lasts less than 20 min.

27: A silicon-graphene-graphite composite for a silicon-based anode of a lithium-ion battery comprising:
silicon particles with a particle size distribution D₅₀ of up to 70 nm wrapped in graphene layers;
graphite particles, a weight ratio of carbon to silicon being between 1.5 and 19; and
a first organic solvent, the viscosity of the silicon-graphene-graphite composite being between 0.025 and 160 Pa·s at 1 s⁴ shear rate.

28: An active material for a silicon-based anode of a lithium-ion battery comprising:
a silicon-graphene-graphite composite, the silicon-graphene-graphite composite including:
silicon particles with a particle size distribution D₅₀ of up to 70 nm wrapped in graphene layers; and
graphite particles, a weight ratio of carbon to silicon being between 1.5 and 19.

29: A silicon-based anode of a lithium-ion battery comprising the active material as recited in claim 28.

30: A lithium-ion battery comprising the silicon-based anode as recited in claim 29.
